(19) United States
(12) Patent Application Publication
(10) Pub. No.: US 2003/0033269 A1
(43) Pub. Date: Feb. 13, 2003

(54) Method, system and program product for maintaining information regarding an item

(76) Inventor: Timothy Michael Ebertshauser, Milford, CT (US)

Correspondence Address: John S Beulick, Armstrong Teasdale LLP, One Metropolitan Square, Suite 2600, St Louis, MO, 63102, US

(21) Appl. No.: 09/751,199

(22) Filed: Jan. 2, 2001

(51) Int. Cl. G06F 7/00

(52) U.S. Cl. 707/1

(57) ABSTRACT

Information regarding an item requiring maintenance, for example, a house, is received. The information includes at least one specification for the item. For example, where the item is a house, the information could include house plans. The information is stored in an electronic database, and access thereto is provided to a user. For example, the access could be provided via a global computer network. Additional information is provided to the user regarding at least one of repairs, maintenance, upgrades, add-ons, replacements, and costs for work respecting the item, based on the item information stored in the electronic database.

### BACKGROUND OF THE INVENTION

The present invention generally relates to effecting commerce, and, more particularly, to maintaining information about an item for the purpose of providing further information related to the item in an attempt to facilitate commerce related to the item.

As the INTERNET is becoming more commercially oriented, providers of products/services are exploring ways to promote, sell and provide product/service information to customers. Such efforts have included a company establishing a site on the World Wide Web, accessed through a browser, on a computer connected to the INTERNET. Such Web sites provide large quantities of information on products/services offered by the particular company.

However, it can be challenging for owners or caretakers of items requiring maintenance to access all the information available on the various Web sites, and to even keep their own records regarding those items. For example, a homeowner can have vast quantities of information about their home, for example, the fixtures and appliances therein. Due to a variety of factors, homeowners tend not to keep all of this information, or do not keep it organized in a readily accessible fashion. Such information, if readily accessible, would enhance the ability of the homeowner to maintain their home, and, thus, help maintain its value.

Therefore, a need exists for a way to maintain information regarding an item requiring maintenance such that it is organized and readily accessible.

### SUMMARY OF THE INVENTION

The present invention provides, in one aspect, a method of maintaining information regarding an item. The method comprises receiving information regarding at least one specification for the item, wherein the item requires maintenance, storing the information in an electronic database, providing electronic access to the information, and providing additional information related to the item based on the information. The additional information is provided in order to encourage commerce related to the item.

System and computer program products corresponding to the above-summarized method are also described and claimed herein.

### BRIEF DESCRIPTION OF THE DRAWINGS

FIG. 1 is a block diagram illustrating one example of a computing environment incorporating and using aspects of the present invention for maintaining information regarding an item.

FIG. 2 is a flow diagram illustrating one example of the logic associated with a method of maintaining information regarding an item, in accordance with the present invention.

FIG. 3 is a flow diagram illustrating one example of the logic associated with obtaining information regarding an item, in accordance with the present invention.

FIG. 4 is a flow diagram illustrating one example of the logic associated with providing additional information related to the item based on the information provided, in accordance with the present invention.

FIGS. 5 and 6 are flow diagrams illustrating examples of the logic associated with a user requesting additional information related to the item, in accordance with the present invention.

FIG. 7 is a flow diagram illustrating one example of the logic associated with a user selling the item and transferring control of the information to the buyer, in accordance with the present invention.

### DETAILED DESCRIPTION OF THE INVENTION

In accordance with one aspect of the present invention, information about an item requiring maintenance is maintained in an electronic database and electronic access thereto is provided (e.g., to an owner of the item). Additional information related to the item is provided (e.g., electronically) based on the information in the electronic database in order to encourage commerce related to the item.

As used herein, the term “item” is intended to be broadly interpreted, including physical things, animals and even humans. As used herein, the term “user” broadly refers to a person or organization closely associated with the item, e.g., an owner of the item or authorized agent thereof, or one charged with overseeing the care of that item.

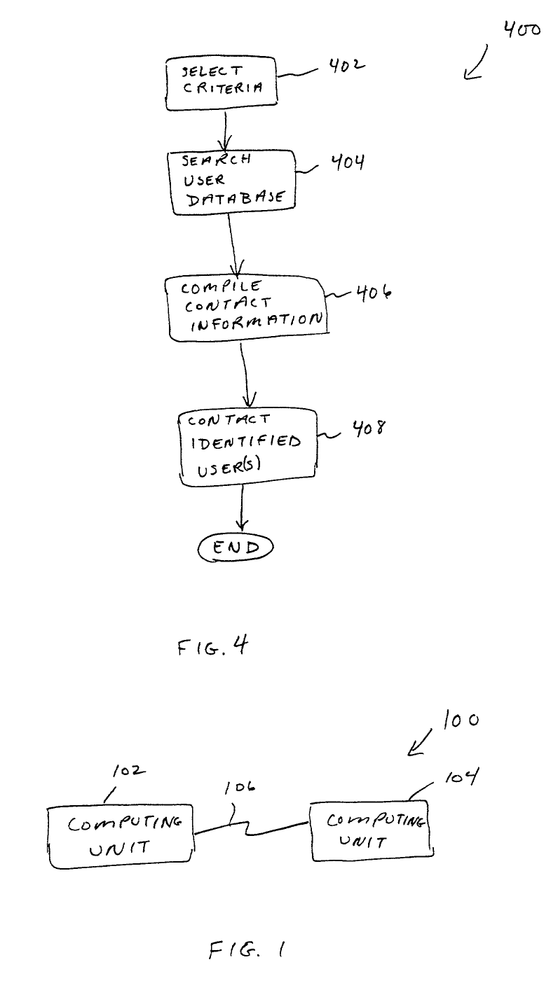

One embodiment of a computing environment incorporating and using the capabilities of the present invention is described with reference to FIG. 1. A computing environment 100 includes, for instance, at least one computing unit 102 coupled to at least one computing unit 104. In one example, computing unit 102 is a server, while computing unit 104 is a client. Each unit includes, for example, one or more central processing units, memory and one or more input/output devices, as is well known in the art.

Computing unit 102 is based, for instance, on the Enterprise Systems Architecture (ESA)/390 offered by International Business Machines Corporation, Armonk, N.Y. One example of a computing unit based on ESA/390 is the 9672 Parallel Enterprise Server offered by International Business Machines Corporation. A suitable operating system is IBM's Multiple Virtual Storage (MVS) operating system. Alternatively, computing unit 102 is, for example, a Hewlitt Packard system running HP-UX, a Unix derivative operating system.

Computing unit 104 is, for instance, a personal computer, such as a personal computer (PC) executing Microsoft WINDOWS, which runs on the Intel PC architecture.

Computing unit 102 is coupled to computing unit 104 via a standard connection 106, such as any type of communications network, wire connection, token ring or network connection, to name just a few examples. One example of a communications protocol used by one or more of these connections is TCP/IP.

The above-described computing environment and/or computing units are only offered as examples. The present invention can be incorporated and used with many types of computing units, computers, processors, nodes, systems, work stations and/or environments without departing from the spirit of the present invention. For example, one or more of the units may be based on the UNIX architecture. Additionally, while some of the embodiments described herein are discussed in relation to servers and clients, such embodiments are only examples. Other types of computing environments can benefit from the present invention and are thus, considered a part of the present invention.

Additionally, in various aspects of the present invention, the client need not be remote from the server. Various aspects of the invention are equally applicable to clients and servers running on the same physical machine, different physical machines or any combinations thereof.

Connection 106 may comprise, for example, a local area network or a global computer network such as the INTERNET which comprises a vast number of computers and computer networks that are interconnected through communication links. The interconnected computers exchange information using various services, such as electronic mail, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a user computer system specifies the URL for that Web page in a request (e.g., a HyperText Transfer Protocol (“HTTP”) request). The request is forwarded to the Web server that supports that Web page. When that Web server receives the request, it sends that Web page to the user computer system. When the builder or home-buyer computer system receives that Web page, it typically displays the Web page using a browser. A browser is a special-purpose application program that effects the requesting of Web pages and the displaying of Web pages. A user computer system may utilize a browser such as Microsoft Internet Explorer® or Netscape Navigator®, for example.

Web pages are typically defined using HyperText Markup Language (“HTML”). HTML provides a standard set of tags that define how a Web page is to be displayed. When a user indicates to the browser to display a Web page, the browser sends a request to the server computer system to transfer to the builder or home-buyer computer system an HTML document that defines the Web page. When the requested HTML document is received by the user computer system, the browser displays the Web page as defined by the HTML document. The HTML document contains various tags that control the displaying of text, graphics, controls, and other features. The HTML document may also contain URLs of other Web pages available on that server computer system or other server computer systems.

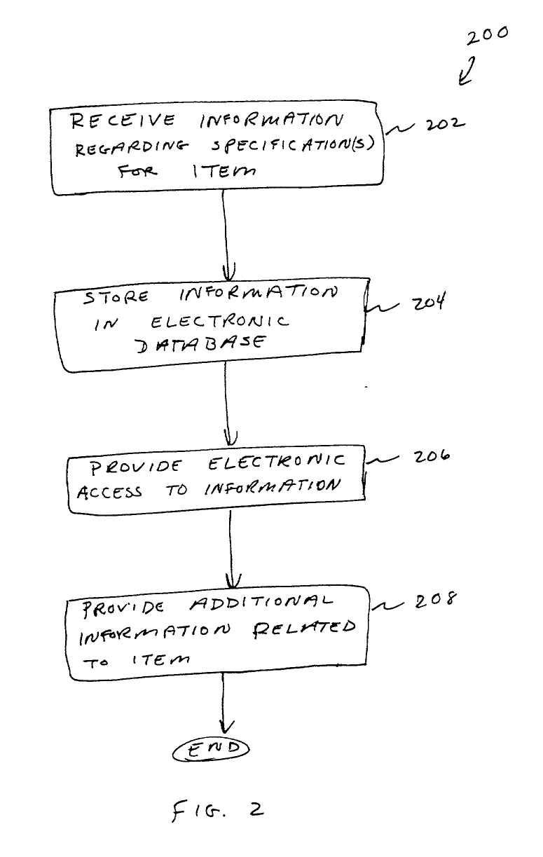

One example of the logic used to implement the present invention is described with reference to FIGS. 2-7. FIG. 2 is a high-level flow diagram 200 of a method of maintaining information regarding an item requiring maintenance, in accordance with one aspect of the present invention. Information regarding at least one specification for the item is received (Step 202). The information received is stored in a conventional electronic database (Step 204). Electronic access to the information is provided (Step 206), and additional information related to the item, based on the information stored in the electronic database, is also provided (Step 208). The electronic access can take several forms. For example, the electronic access can be via computer over a communications network, such as that described with respect to FIG. 1. As another example, the electronic access can be via touch-tone or wireless phone, or other electronic device.

The method may be, for example, applied to the computing environment 100 of FIG. 1. In such a scenario, assume that computing unit 102 is a server for a site available to a user from computing unit 104 over a global computer network 106. Further, assume for this example that the item is a house owned by the user. The site offers, for example, a service where information about items requiring maintenance, such as, for example, a house, are stored in an electronically accessible database (e.g., a relational database, such as that available from Oracle Corporation, Redwood Shores, Calif.) controlled by the site for easy access by the users who sign up for the service. The service also provides additional information to the user related to the item. Additional information related to a house could include, for example, details about common types of maintenance and repairs and contacts with maintenance and repair services in the user's geographic area. The additional information could also include, for example, reminders (e.g., by electronic mail, physical mail, or even by phone) to do maintenance and/or repairs. The reminders may also be made through the use of a calendar service. The additional information could also include, for example, suggestions for upgrades to fixtures within the house or construction upgrades to the house itself, add-ons, complementary products, replacements and estimates for work desired by the user to be done to the house by professionals.

Receipt of the information regarding the house (Step 202, FIG. 2) may be accomplished in at least two ways. One way is for the user to manually enter the information, for example, in response to selected queries from the service site and/or the user could upload one or more electronic files containing some or all of the requested information. With respect to a house, the information might include, for example, drawings showing the layout of the house, a list of materials used to build the house, a list of the appliances in the house including manufacturers and model numbers, a list of the fixtures including manufacturers and model numbers, lot size, warranty information, personal inventory, repair and/or maintenance information, and even contact information for the contractors and subcontractors who built the house in order to facilitate repairs. It may be the case that the user simply does not have access to some of the information. In that case, the user can come back later to fill in the missing information, or simply use the service with the limited information available. However, as much information as possible is preferred, since more information will generally increase the opportunities to encourage commerce related to the item (here, a house). Another way to accomplish receipt of the information regarding the house (Step 202, FIG. 2) is to transfer some or all of the information from an existing electronic database compiled by the user, the builder of the house or a third party.

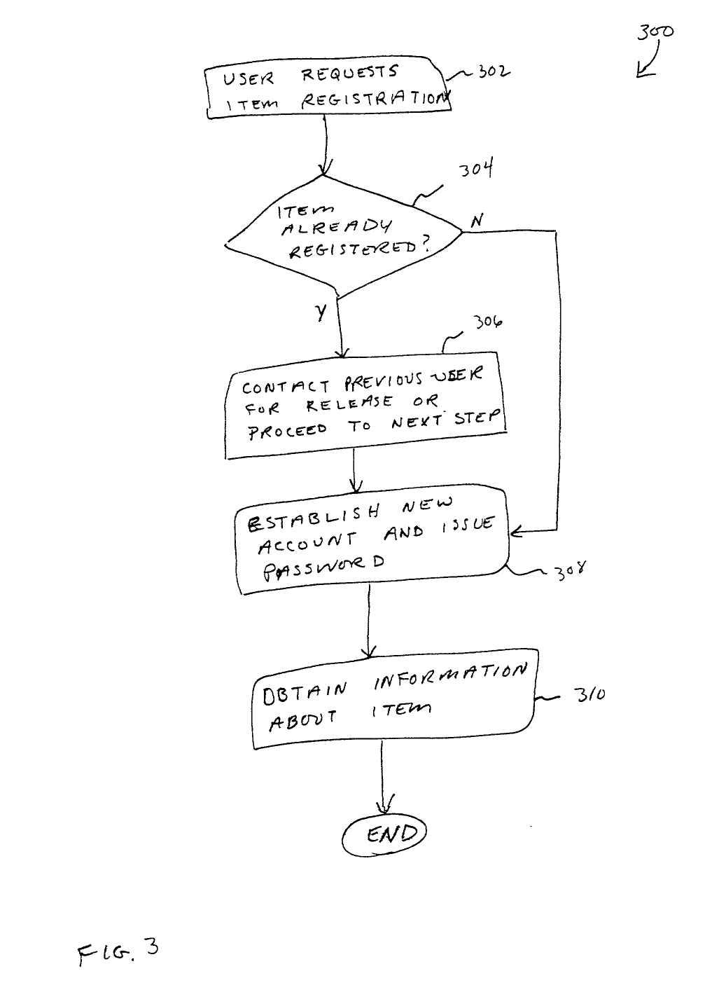

FIG. 3 is a flow diagram 300 of one example of how the information regarding the item is received, described with reference to the house example given above. Although not necessary for the invention, when the user first visits the site, the user may be given the opportunity to register with the site, by providing various information, such as, for example, name and e-mail address, and may also be requested to choose a user name and password or other unique data pattern to provide access. This merely recognizes that, as a practical matter, the operator of the site will want to be able to identify the user in some way. This could also be done, as another example, using what are known as “cookies,” which are small programs loaded onto the user's computer (here, computing unit 104) from the site (here, computing unit 102) that identify the user to computing unit 102.

Returning now to FIG. 3, the user requests registration of an item for information maintenance by the site (Step 302). This could be done, for example, by providing a graphical item registration form to the user, with various queries that are responded to by the user, for example, the type of item and/or the location of same. Further, to restrict the type of items that can be registered, the site may force the user to choose from a limited list, and remove the ability to fill in something other than what is listed, e.g., using a standard drop-down menu. An inquiry is then made by the service as to whether the item is already registered with the service, for example, by a previous owner/user (Step 304). This can be accomplished by a simple database search for the home address, in this example.

If the item was previously registered, the service may contact the previous user shown in its records for permission to release the information to the new user (Step 306), or simply proceed to establish a new account with a new user name and password (Step 308), which is also done if the it is determined that the item was not previously registered in Step 304 or that the answer to the query cannot be determined. In either case, the information about the item is obtained (Step 310). However, if there were a previous user, and he or she releases the information, the information would already be stored in the database.

During the course of the user's relationship with the information maintenance service, the user will preferably be encouraged to periodically update the information about the house, for example, where an old appliance is replaced with a new one, or where a renovation is made.

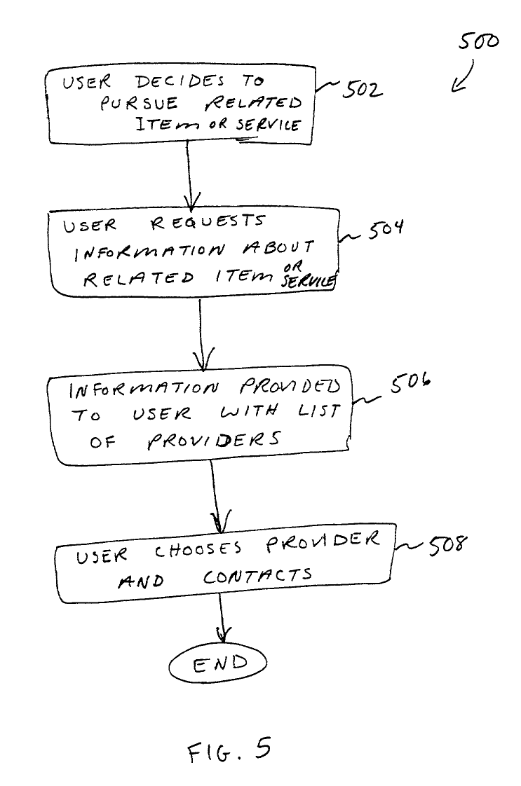

FIG. 4 is a flow diagram 400 for one example implementing the step of providing additional information related to the item (Step 208, FIG. 1). Assume for the purposes of this example that the information maintenance service wishes to provide information to its relevant users regarding home additions. The information maintenance service first selects one or more criteria for identifying relevant users of its service (Step 402). In the present example, the sole criterion could be home ownership broadly, i.e., all users that have registered a house as the item for which information is being maintained by the service. As another example, the criteria could be home ownership and a previous visit to a section of the service's site related to home additions. Based on the selected criteria, the service searches its user database for users satisfying the criteria (Step 404), compiling a list of, for example, e-mail addresses associated with those users (Step 406). The information regarding home additions is then disseminated to the identified users by sending the information in an e-mail (Step 408). It will be understood that other types of information could be provided, and that other methods of contacting the identified users could be used (e.g., phone, regular mail, etc.).

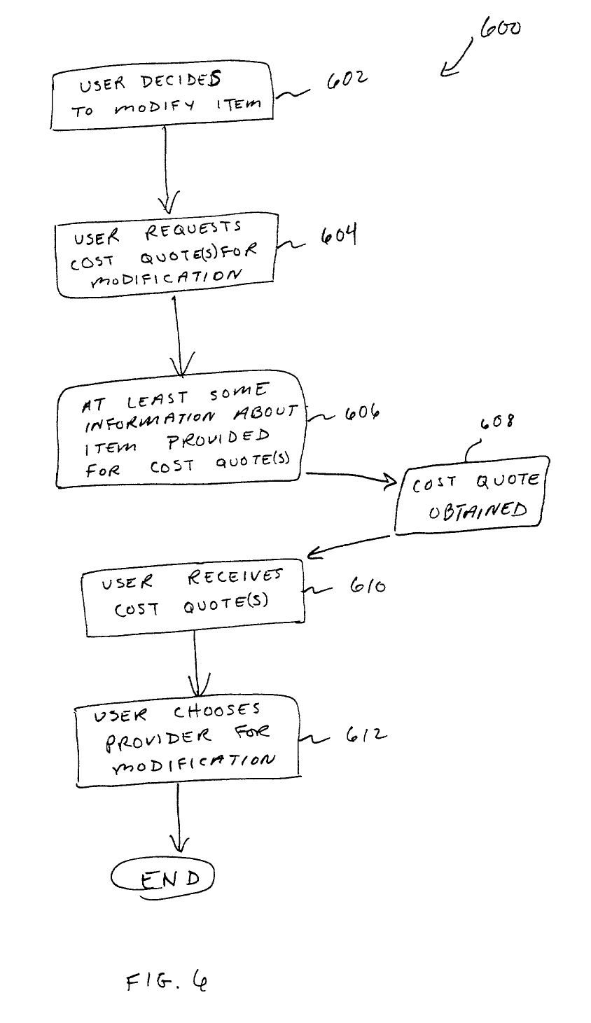

In response to the additional information provided, a user may decide to pursue, for example, making a purchase related to the item for which information is being maintained. FIG. 5 is a flow diagram 500 of one example of such a scenario, described first in the context of the home addition situation described with respect to FIG. 4. As a result, in whole or in part, of receiving the information regarding home additions, assume that the user decides to pursue a home addition (Step 502). The initial investigation could take various forms. For example, the user could request more detailed information, which could occur in a number of ways. One way is that the e-mail that the user received from the information maintenance service could include a hyperlink to a page on the service's site providing the more detailed information, such as, for example, a list of contacts for such services (Step 506). As another example, the linked page on the service's site could also include hyperlinks to shopping services. As still another example, the e-mail that was received by the user could have contained the list of contacts. From the service's perspective, the link to a page on its site is preferable where the page provides one or more additional links to sites of service providers, the visiting of which could be confirmed by, for example, the use of a “cookie” placed on the user's computer. This tracking may be relevant for referral fee or profit sharing agreements between the information maintenance service and the providers. In any case, the user then chooses a provider and contacts them for further information or, for example, to schedule a visit (Step 508).

As another example, FIG. 5 also relates to a situation where the homeowner seeks to replace an appliance or fixture. In this scenario, Step 504 takes the form of the user performing a search using a search engine provided by or affiliated with the information maintenance service. The results of the search include the listing of providers noted in Step 506.

The provision of further information to a user (Step 208, FIG. 2) related to the item for which information is being maintained could also be more passive in nature. For example, the additional information could be provided in response to a user clicking on an advertisement of a provider or a retailer. The information could also simply be in one or more sections of the service's site, with a hyperlink on, e.g., the home page, requiring an affirmative action on the part of a user to review. A user taking the time to review such information is generally indicative of that user's at least partial interest in the topic (in the present example, home additions).

FIG. 6 is a flow diagram 600 of one example of a more passive situation of providing a user with further information, in the context of the homeowner example given above. On his or her own, a user may determine that he or she desires to have an addition to their home built, and the house is the subject of information maintenance by the service (Step 602). After being logged into the service's site, the user requests a cost quote for having an addition put onto their home (Step 604). This could be done, for example, by the user clicking a “quote” button, acting as a link to another page in the service's site providing a form to be filled out and submitted. The necessary information is determined by, for example, the service in conjunction with one or more contractors with a presence in the user's area. At least some information about the house is provided by the user as part of the submission (Step 606), especially where the user desires a cost estimate without a visit from a provider. For example, the user might append house plans stored with the service, a digital photo of the house in any of the common formats (e.g., JPEG and TIFF), or other relevant information.

After the form is filled out and submitted to the information maintenance service, the service could, for example, forward the information to one or more contractors in the user's area (Step 608). The contractors preferably have an existing relationship with the service to provide such cost information. When the provider(s) have completed their cost estimate(s), they can be provided directly to the user, or through the service as an intermediary (Step 610). From the cost estimates provided, the user can choose from the providers responding, and proceed to authorize the work or schedule a formal meeting, for example (Step 612).

As an alternative to filling out the form or in conjunction therewith, the service could provide a mechanism whereby the user can give providers authorized by the user temporary access to the information stored regarding the house on the service's database (e.g., a password or other unique data pattern that expires within a given amount of time that is preset or chosen by the user). The temporary access may also be read-only to prevent any modification of the information stored regarding the item. In this way, each provider can access the information it deems relevant to provide the estimate. In construction type situations, however, it is reasonable to assume that the user will at least need to specify the type of addition they want and the size, or other information not present in the database, for the provider(s) to give an estimate.

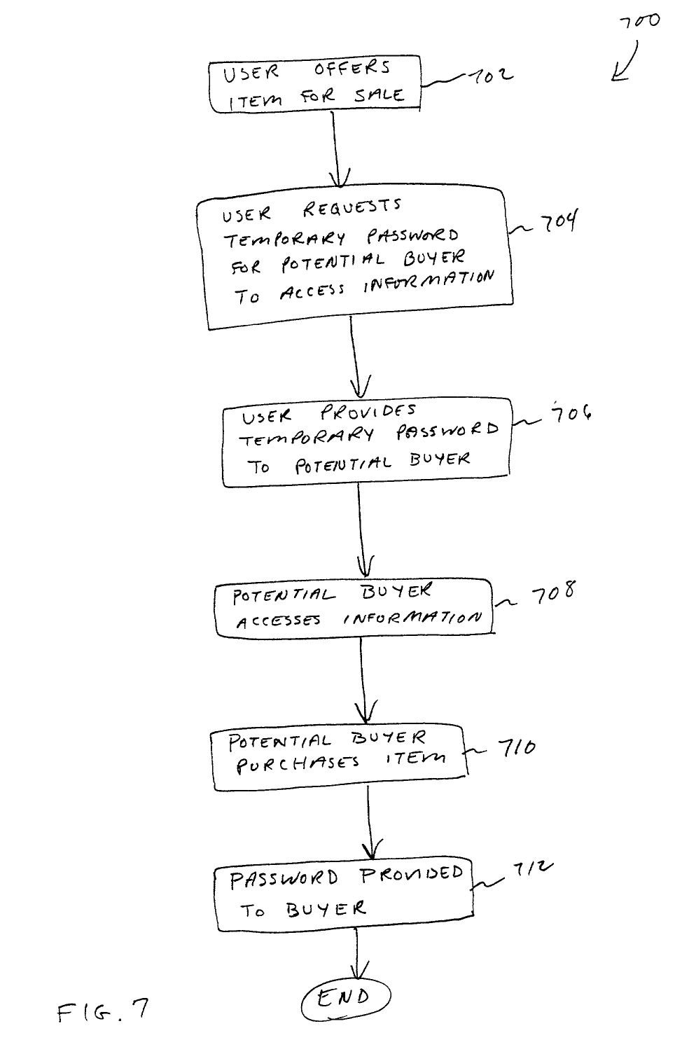

The information maintenance service may spend years developing a relationship with a given user, for example, a home owner. As a result, the information stored regarding the item (here, a house) would be a valuable tool for assisting the user in selling the item, which many buyers would be interested in receiving from the seller as part of the purchase. FIG. 7 is a flow diagram 700 of one example of a process for transferring the information in the database regarding the item to a new user. After the user (here, an owner) decides to offer the item for sale (Step 702), the user requests from the service a temporary password or other unique data pattern to give a potential buyer temporary access to the information (Step 704). As noted above, the temporary access may also be read-only to prevent modification of the information stored regarding the item. When the user decides a prospective buyer has a sufficient level of interest, the user could provide the temporary password or other unique data pattern thereto (Step 706). Such access by the potential buyer (Step 708) would enable the potential buyer to investigate the item further, and, if records are kept up-to-date, could help to convince the potential buyer to purchase the item (Step 710). Upon completion of the item purchase, control of the information regarding the item is in some manner transferred to the purchaser. For example, the user could simply provide the permanent password or other permanent data pattern to the buyer (Step 712), who could then log onto the service and update the user information and even change the permanent password. Alternatively, the user could notify the service of the sale of the item, and provide the contact information for the buyer.

Although the present invention was described with respect to a house, it will be understood that it is applicable to other items. For example, the item may be an automobile and the information may comprise, for example, schematics, identification of manufacturing materials or components, a vehicle identification number, and a manufacturer-recommended maintenance schedule. As another example, the item may be a house pet, and the information may comprise, for example, species, breed, sex, lineage and health history. As yet another example, the item may be a human, and the information may be, for example, sex, age, ethnicity and health history. As still a further example, the item could be a lawn, and the information could include, for example, location, relative amounts of sun and shade, grass type, and chemical application history.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just exemplary. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A method of maintaining information regarding an item, comprising:
receiving information regarding at least one specification for the item, wherein the item requires maintenance;
storing the information in an electronic database;
providing electronic access to the information; and
providing additional information related to the item based on the information in order to encourage commerce related to the item.

2. The method of claim 1, further comprising sending the information from a first computing unit prior to the receiving, wherein the receiving comprises receiving the information at a second computing unit coupled to the first computing unit via a communications network.

3. The method of claim 2, wherein the receiving comprises receiving the information at a second computing unit coupled to the first computing unit via a global computer network.

4. The method of claim 1, further comprising transferring the information from another database prior to the receiving, wherein the receiving comprises receiving the information from the another database.

5. The method of claim 1, wherein the storing comprises storing the information in a relational electronic database.

6. The method of claim 1, wherein providing electronic access comprises providing electronic access to the information via a computing unit coupled to the electronic database via a communications network.

7. The method of claim 6, wherein providing electronic access comprises providing electronic assess to the information via a computing unit coupled to the electronic database via a global computer network.

8. The method of claim 1, further comprising associating a unique data pattern with the information for access thereto, and wherein providing electronic access is only performed if the unique data pattern is first received.

9. The method of claim 1, wherein the item comprises a building, and wherein the information comprises at least one of building plans, a building material identification, a building component identification, an appliance identification, and a contractor identification.

10. The method of claim 1, wherein providing the additional information is performed in response to a request therefor.

11. The method of claim 1, wherein providing the additional information comprises:
receiving a request for at least one cost quote from at least one provider for work desired respecting the item;
obtaining the at least one cost quote; and
returning the at least one cost quote to the requestor.

12. The method of claim 11, wherein receiving the request comprises electronically receiving the request and providing at least some of the information stored in the database to the at least one provider to determine the at least one cost quote.

13. The method of claim 11, wherein the requesting comprises:
associating at least one temporary data pattern with the item; and
providing the at least one temporary data pattern to the at least one provider for temporary access to the information thereby.

14. The method of claim 1, further comprising associating a temporary data pattern with the item for allowing temporary access to at least some of the information by a potential purchaser of the item.

15. The method of claim 14, further comprising associating a data pattern with the information for full access thereto, wherein providing electronic access is performed only if the data pattern is first received, the method further comprising providing the data pattern to the potential purchaser for full access to the information upon purchasing the item.

16. The method of claim 15, further comprising associating a new data pattern with the item and disassociating the data pattern from the item.

17. The method of claim 1, wherein providing the additional information comprises providing information regarding at least one of repairs, maintenance, upgrades, add-ons, complementary products, replacements, and costs for work respecting the item.

18. The method of claim 1, wherein the item comprises an automobile, and wherein the information comprises at least one of schematics, a manufacturing material identification, a manufacturing component identification, a vehicle identification number, and a manufacturer-recommended maintenance schedule.

19. The method of claim 1, wherein the item comprises a pet, and wherein the information comprises at least one of species, breed, sex, lineage, and health history.

20. The method of claim 1, wherein the item comprises a human, and wherein the information comprises at least one of sex, age, ethnicity, and health history.

21. The method of claim 1, wherein the item comprises a lawn, and wherein the information comprises at least one of location, relative amount of sun and shade received, grass type, and chemical application history.

22. The method of claim 1, wherein providing the additional information comprises electronically providing the additional information.

23. A system for maintaining information regarding an item, comprising:
means for receiving information regarding at least one specification for the item, wherein the item requires maintenance;
an electronic database for storing the information;
means for providing electronic access to the information; and
means for providing additional information related to the item based on the information in order to encourage commerce related to the item.

24. The system of claim 23, further comprising a first computing unit for sending the information, wherein the means for receiving comprises a second computing unit coupled to the first computing unit.

25. The system of claim 24, wherein the second computing unit is coupled to the first computing unit via a global computer network.

26. The system of claim 23, further comprising another electronic database first storing the information, and wherein the means for receiving comprises means for transferring the information from the another electronic database to the electronic database.

27. The system of claim 23, wherein the electronic database comprises a relational electronic database.

28. The system of claim 23, wherein the means for providing electronic access comprises a computing unit coupled to the electronic database.

29. The system of claim 28, wherein the computing unit is coupled to the electronic database via a global computer network.

30. The system of claim 23, further comprising means for associating a unique data pattern with the information for access thereto, and wherein the means for providing electronic access comprises means for first receiving and verifying the unique data pattern prior to providing electronic access to the information.

31. The system of claim 23, wherein the item comprises a building, and wherein the information comprises at least one of building plans, a building material identification, a building component identification, an appliance identification, and a contractor identification.

32. The system of claim 23, wherein the means for providing the additional information comprises means for providing the additional information in response to a request therefor.

33. The system of claim 23, wherein the means for providing the additional information comprises:
means for receiving a request for at least one cost quote from at least one provider for work desired respecting the item; and
means for returning the at least one quote to the requestor.

34. The system of claim 33, wherein the means for receiving the request comprises means for electronically receiving the request for the at least one cost quote, the system further comprising means for providing at least some of the information stored in the database to the at least one provider to determine the at least one quote.

35. The system of claim 33, wherein the means for providing at least some of the information comprises:
means for associating at least one unique temporary data pattern with the item; and
means for providing the at least one unique temporary data pattern to the at least one provider for temporary access to the information thereby.

36. The system of claim 23, further comprising means for associating a unique temporary data pattern with the item for allowing temporary access to at least some of the information by a potential purchaser of the item.

37. The system of claim 23, further comprising means for associating a unique data pattern with the information for at least partial access thereto.

38. The system of claim 37, further comprising means for associating a different unique data pattern with the item and disassociating the unique data pattern from the item.

39. The system of claim 23, wherein the means for providing the additional information comprises means for providing information regarding at least one of repairs, maintenance, upgrades, add-ons, complementary products, replacements, and costs for work respecting the item.

40. At least one program storage device readable by a machine, tangibly embodying at least one program of instructions executable by the machine to perform a method maintaining information regarding an item, the method comprising:
receiving information regarding at least one specification for the item, wherein the item requires maintenance;
storing the information in an electronic database;
providing electronic access to the information; and
providing additional information related to the item based on the information in order to encourage commerce related to the item.

41. The at least one program storage device of claim 40, the method further comprising sending the information from a first computing unit prior to the receiving, wherein the receiving comprises receiving the information at a second computing unit coupled to the first computing unit via a communications network.

42. The at least one program storage device of claim 41, wherein the receiving comprises receiving the information at a second computing unit coupled to the first computing unit via a global computer network.

43. The at least one program storage device of claim 40, the method further comprising transferring the information from another database prior to the receiving, wherein the receiving comprises receiving the information from the another database.

44. The at least one program storage device of claim 40, wherein the storing comprises storing the information in a relational electronic database.

45. The at least one program storage device of claim 40, wherein providing electronic access comprises providing electronic access to the information via a computing unit coupled to the electronic database via a communications network.

46. The at least one program storage device of claim 45, wherein providing electronic access comprises providing electronic assess to the information via a computing unit coupled to the electronic database via a global computer network.

47. The at least one program storage device of claim 40, the method further comprising associating a unique data pattern with the information for access thereto, and wherein providing electronic access is only performed if the unique data pattern is first received.

48. The at least one program storage device of claim 40, wherein the item comprises a building, and wherein the information comprises at least one of building plans, a building material identification, a building component identification, an appliance identification, and a contractor identification.

49. The at least one program storage device of claim 40, wherein providing the additional information is performed in response to a request therefor.

50. The at least one program storage device of claim 40, wherein providing the additional information comprises:
receiving a request for at least one cost quote from at least one provider for work desired respecting the item;
obtaining the at least one cost quote; and
returning the at least one cost quote to the requestor.

51. The at least one program storage device of claim 50, wherein receiving the request comprises electronically receiving the request and providing at least some of the information stored in the database to the at least one provider to determine the at least one cost quote.

52. The at least one program storage device of claim 50, wherein the requesting comprises:
associating at least one temporary data pattern with the item; and
providing the at least one temporary data pattern to the at least one provider for temporary access to the information thereby.

53. The at least one program storage device of claim 40, the method further comprising associating a temporary data pattern with the item for allowing temporary access to at least some of the information by a potential purchaser of the item.

54. The at least one program storage device of claim 53, the method further comprising associating a data pattern with the information for full access thereto, wherein providing electronic access is performed only if the data pattern is first received, the method further comprising providing the data pattern to the potential purchaser for full access to the information upon purchasing the item.

55. The at least one program storage device of claim 54, the method further comprising associating a new data pattern with the item and disassociating the data pattern from the item.

56. The at least one program storage device of claim 40, wherein providing the additional information comprises providing information regarding at least one of repairs, maintenance, upgrades, add-ons, complementary products, replacements, and costs for work respecting the item.

57. The at least one program storage device of claim 40, wherein the item comprises an automobile, and wherein the information comprises at least one of schematics, a manufacturing material identification, a manufacturing component identification, a vehicle identification number, and a manufacturer-recommended maintenance schedule.

58. The at least one program storage device of claim 40, wherein the item comprises a pet, and wherein the information comprises at least one of species, breed, sex, lineage, and health history.

59. The at least one program storage device of claim 40, wherein the item comprises a human, and wherein the information comprises at least one of sex, age, ethnicity, and health history.

60. The at least one program storage device of claim 40, wherein the item comprises a lawn, and wherein the information comprises at least one of location, relative amount of sun and shade received, grass type, and chemical application history.

61. The at least one program device of claim 40, wherein providing the additional information comprises electronically providing the additional information.
